(19) United States
(12) Patent Application Publication
(10) Pub. No.: US 2010/0053264 A1
(43) Pub. Date: Mar. 4, 2010

(54) INKJET PRINTER AND PRINTING METHOD USING THE SAME

(75) Inventors: Sung-Nam Cho, Buyeo-gun (KR); Jae-Woo Joung, Suwon-si (KR); Sung-II Oh, Seoul (KR)

Correspondence Address: MCDERMOTT WILL & EMERY LLP, 600 13TH STREET, N.W., WASHINGTON, DC, 20005-3096, US

(73) Assignee: SAMSUNG ELECTRO-MECHANICS CO., LTD.

(21) Appl. No.: 12/430,443

(22) Filed: Apr. 27, 2009

(30) Foreign Application Priority Data
Aug. 28, 2008 (KR) 10-2008-0084654

(51) Int. Cl. B41J 2/145

(52) U.S. Cl. 347/40

(57) ABSTRACT

An inkjet printer and a printing method using the inkjet printer are disclosed. The inkjet printer in accordance with an embodiment of the present invention can include: a first inkjet head, which prints in one direction; and a second inkjet head, which prints in a different direction intersecting the one direction. In accordance with an embodiment of the present invention, the inkjet printer can print a pattern having a plurality of directions with a stable printing quality.

### CROSS-REFERENCE TO RELATED APPLICATIONS

This application claims the benefit of Korean Patent Application No. 10-2008-0084654, filed with the Korean Intellectual Property Office on Aug. 28, 2008, the disclosure of which is incorporated herein by reference in its entirety.

### BACKGROUND

1. Technical Field

The present invention relates to an inkjet printer and a printing method using the inkjet printer.

2. Description of the Related Art

Inkjet printing is a cost-saving, environment-friendly, process-simplifying technology, and thus has become an accomplished new printing technology. Particularly, a variety of attempts have led to new applications in the field of electronics industry as a method that saves time and money in a much more simple and cost-effective way compared to the conventional photo printing process.

The earlier applications of the inkjet printing method in the electronics industry mainly focused on spraying the ink through an inkjet head. Over the years, however, the inkjet printing method has developed to a process for forming a wiring pattern.

In the beginning, the method of forming a wiring pattern using the inkjet printing method was mainly used to form a relatively big wiring pattern of at least 100 um. In recent years, however, there has been an attempt to use the method in a fine wiring pattern that is 20 um or less. As a result, securing the precision of print patterns has become a main task in the fine patterning process for the method of forming a wiring pattern using the inkjet printing method.

Specifically, a single inkjet head has approximately 128 to 508 nozzles. When each nozzle of the single inkjet head prints, there is a 5% margin of error due to a variety of reasons, for example, drop size variation, jet straightness, drop velocity variation and crosstalk. Moreover, as the use of a multi-head becomes popular to increase the printing speed, an error occurs due to a deviation among the heads of the multi-head.

The deviation among the heads in a multi-head and the deviation between multi-heads cause a difference in quality between a horizontal print pattern and a vertical print pattern. This is because the conventional inkjet printing method has one directional orientation in the printing, and thus the wiring formed in the same direction as the printing and the wiring formed in the different direction from the printing have a difference in printing precision.

FIGS. 1 and 2 are plan views illustrating a vertical wiring pattern and a horizontal wiring pattern formed by a conventional inkjet printer. As illustrated in FIGS. 1 and 2, the conventional inkjet printer prints in one direction (the vertical direction) only. After printing a first row in the vertical direction, a next row is printed by moving in the horizontal direction, and then the process is repeated to form a wiring pattern.

As illustrated in FIG. 1, a vertical pattern is formed as a nozzle continuously sprays along the direction of the pattern, i.e., the vertical direction, and thus is not affected by errors occurred by the heads. As illustrated in FIG. 2, however, a horizontal pattern, which is formed at an angle of 90 degrees to the printing direction, i.e., the vertical direction, is formed by intermittent spraying from a plurality of nozzles as the plurality of nozzles move in the vertical direction, and thus errors occurred by the heads lead to an erroneous wiring pattern. As a result, there is a difference in quality between the horizontal wiring pattern and the vertical wiring pattern.

Particularly, the error in the horizontal wiring pattern makes the wiring pattern thick, making the wiring pattern in contact with an adjacent pad and causing product defect.

### SUMMARY

The present invention provides an inkjet printer and a printing method using the inkjet printer that print a pattern having a plurality of directions with a stable printing quality.

An aspect of the present invention provides an inkjet printer. The inkjet printer in accordance with an embodiment of the present invention can include: a first inkjet head, which prints in one direction; and a second inkjet head, which prints in a different direction intersecting the one direction.

The one direction of printing of the first inkjet head can intersect the different direction of printing of the second inkjet head at right angles.

The first inkjet head and the second inkjet head can have a position reference point becoming a reference for aligning a inkjet head, and the position reference point of the second inkjet head can be directed toward the different direction and be located on a straight line passing through the position reference point of the first inkjet head.

The inkjet printer can further include a third inkjet head, which is arranged in parallel with the first inkjet head along the printing direction of the first inkjet head or in parallel with the second inkjet head along the printing direction of the second inkjet head.

Another aspect of the present invention provides a printing method. The printing method in accordance with an embodiment of the present invention can include: separating print data into an x-axis component and a y-axis component; printing the y-axis component by using a first inkjet head printing in the direction of y-axis; and printing the x-axis component by using a second inkjet head printing in the direction of x-axis.

Additional aspects and advantages of the present invention will be set forth in part in the description which follows, and in part will be obvious from the description, or may be learned by practice of the invention.

### BRIEF DESCRIPTION OF THE DRAWINGS

FIGS. 1 and 2 are plan views illustrating a vertical wiring pattern and a horizontal wiring pattern formed by a conventional inkjet printer.

FIG. 3 is a plan view illustrating an inkjet head of an inkjet printer in accordance with an embodiment of the present invention.

FIG. 4 is a plan view illustrating a vertical pattern of an inkjet printer in accordance with an embodiment of the present invention.

FIG. 5 is a plan view illustrating a horizontal pattern of an inkjet printer in accordance with an embodiment of the present invention.

FIG. 6 is a plan view illustrating a pattern formed by an inkjet printer in accordance with an embodiment of the present invention.

FIG. 7 is a plan view illustrating multi-heads of an inkjet printer in accordance with an embodiment of the present invention.

FIG. 8 is a flowchart illustrating a printing method in accordance with an embodiment of the present invention.

FIG. 9 is a conceptual diagram illustrating how to separate data in a printing method in accordance with an embodiment of the present invention.

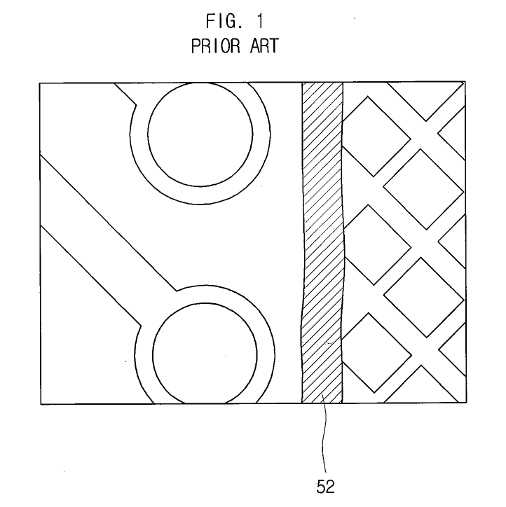

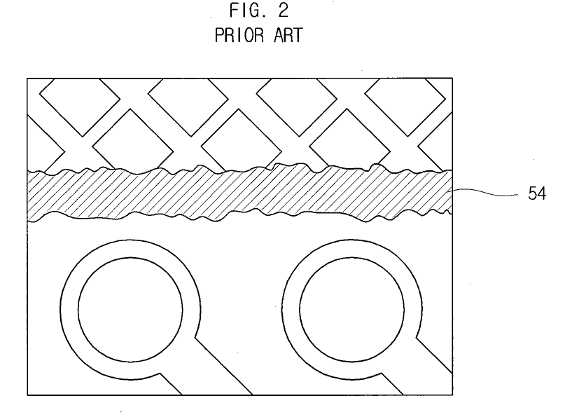

### DETAILED DESCRIPTION

As the invention allows for various changes and numerous embodiments, particular embodiments will be illustrated in the drawings and described in detail in the written description. However, this is not intended to limit the present invention to particular modes of practice, and it is to be appreciated that all changes, equivalents, and substitutes that do not depart from the spirit and technical scope of the present invention are encompassed in the present invention. In the description of the present invention, certain detailed explanations of related art are omitted when it is deemed that they may unnecessarily obscure the essence of the invention.

While such terms as “first” and “second,” etc., may be used to describe various components, such components must not be limited to the above terms. The above terms are used only to distinguish one component from another. For example, a first component may be referred to as a second component without departing from the scope of rights of the present invention, and likewise a second component may be referred to as a first component. The term “and/or” encompasses both combinations of the plurality of related items disclosed and any item from among the plurality of related items disclosed.

The terms used in the present specification are merely used to describe particular embodiments, and are not intended to limit the present invention. An expression used in the singular encompasses the expression of the plural, unless it has a clearly different meaning in the context. In the present specification, it is to be understood that the terms such as “including” or “having,” etc., are intended to indicate the existence of the features, numbers, steps, actions, components, parts, or combinations thereof disclosed in the specification, and are not intended to preclude the possibility that one or more other features, numbers, steps, actions, components, parts, or combinations thereof may exist or may be added.

Unless otherwise defined, all terms used herein, including technical or scientific terms, have the same meanings as those generally understood by those with ordinary knowledge in the field of art to which the present invention belongs. Such terms as those defined in a generally used dictionary are to be interpreted to have the meanings equal to the contextual meanings in the relevant field of art, and are not to be interpreted to have ideal or excessively formal meanings unless clearly defined in the present application.

An inkjet printer and a printing method using the inkjet printer in accordance with certain embodiments of the present invention will be described below in more detail with reference to the accompanying drawings, in which those components are rendered the same reference number that are the same or are in correspondence, regardless of the figure number, and redundant explanations are omitted. Also, the basic principles will first be described before discussing the preferred embodiments of the present invention.

Hereinafter, an embodiment of the present invention will be described in more detail with reference to the accompanying drawings.

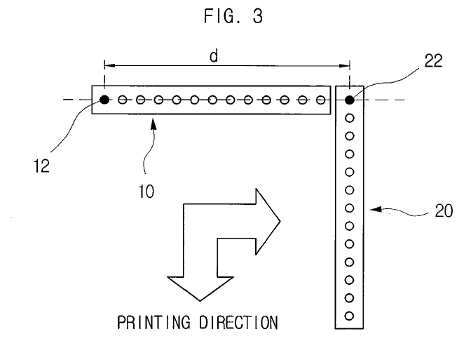

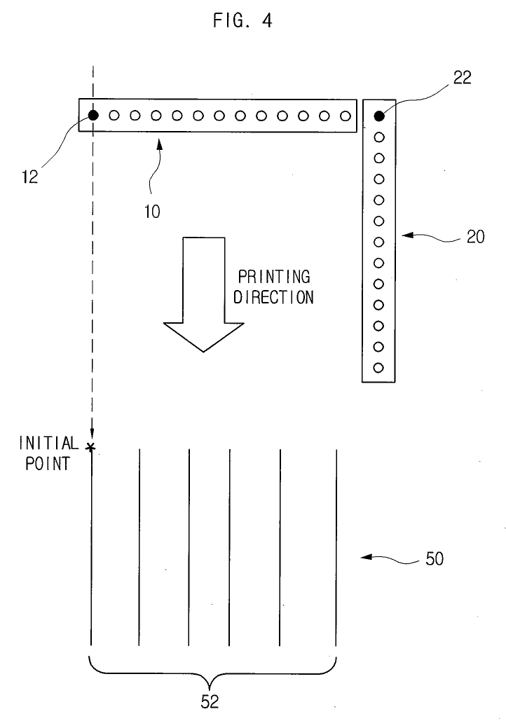

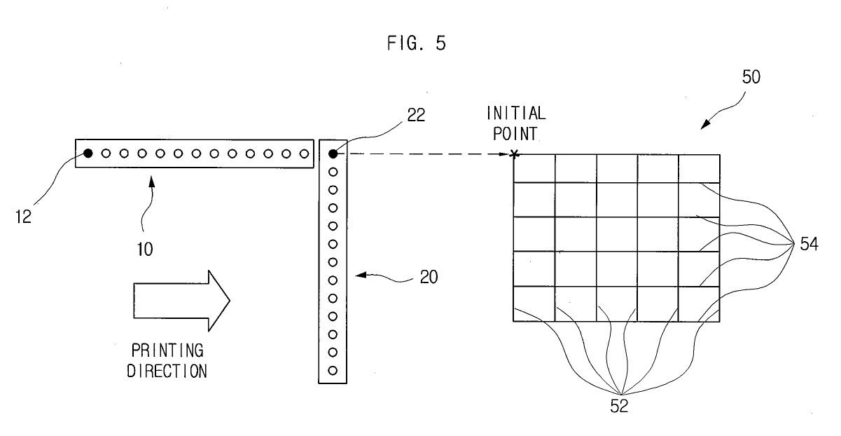

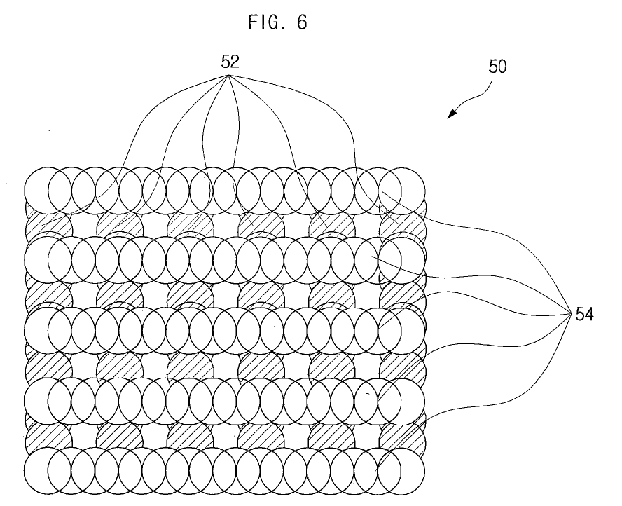

FIG. 3 is a plan view illustrating an inkjet head of an inkjet printer in accordance with an embodiment of the present invention. FIG. 4 is a plan view illustrating a vertical pattern 52 of an inkjet printer in accordance with an embodiment of the present invention. FIG. 5 is a plan view illustrating a horizontal pattern 54 of an inkjet printer in accordance with an embodiment of the present invention. FIG. 6 is a plan view illustrating a pattern 50 formed by an inkjet printer in accordance with an embodiment of the present invention.

Illustrated in FIG. 3 are a first inkjet head 10 and a second inkjet head 20.

The first inkjet head 10 is capable of printing in one direction, and the second inkjet head 20 is capable of printing in a different direction, which intersects the printing direction of the first inkjet head 10. Here, the printing by the first inkjet head 10 in one direction refers to carrying out the printing by the inkjet head 10 by spraying ink on a corresponding object, for example, a board, while moving in one direction. To do this, the first inkjet head 10 can move in one direction, or a stage (not shown) supporting the object to be printed can move in the opposite direction.

The printing direction of the first inkjet head 10 and the printing direction of the second inkjet head 20 can be aligned to be perpendicular to each other. As a result, a print pattern 50 including a horizontal pattern and a vertical pattern can be printed more precisely.

As illustrated in FIG. 3, the first inkjet head 10 and the second inkjet head 20 in accordance with an embodiment of the present invention are aligned such that the vertical pattern 52 and the horizontal pattern 54 can be formed respectively. In the first inkjet head 10, a plurality of nozzles are formed horizontally in a row such that a plurality of vertical patterns 52 can be printed at one time. Likewise, in the second inkjet head 20, a plurality of nozzles are formed vertically in a column such that a plurality of horizontal patterns 54 can be printed at one time.

Referring to FIG. 4 for more detail, a plurality of vertical patterns 52 are formed by the first inkjet head 10. Here, each of the plurality of vertical patterns 52 is formed by a corresponding nozzle, which moves in the vertical direction to spray the ink. Accordingly, nozzles that are not positioned on the same line as the vertical pattern 52 in the vertical direction do not affect a line width of the vertical pattern 52. Moreover, any error in the vertical movement of the first inkjet head 10 causes an error in the vertical direction only, not affecting the line width of the vertical pattern 52. Therefore, the line width of the vertical pattern 52 is not affected by the position error occurred between the nozzles and the vertical movement error of the first inkjet head 10, thereby resulting in a vertical pattern 52 of a precise line width.

Furthermore, referring to FIG. 5, a plurality of horizontal patterns 54 are formed by the second inkjet head 20. The forming of the horizontal pattern 54 is the same as that of the vertical pattern 52 described above.

Therefore, as illustrated in FIG. 6, the inkjet printer in accordance with an embodiment of the present invention can form the print pattern 50 having a plurality of directions with uniform precision.

Each of the first inkjet head 10 and the second inkjet head 20 has a position reference point, which becomes a reference for aligning the heads. A position reference point 22 of the second inkjet head can face a different direction and be located on a straight line passing through a position reference point 12 of the first inkjet head 10.

As described above, the vertical pattern 52 and the horizontal pattern 54 are formed individually by each corresponding head. Therefore, to align the overall print pattern 50, the same reference is needed. To do this, as illustrated in FIGS. 4 and 5, the first inkjet head 10 and the second inkjet head 20 have the position reference points 12 and 22, respectively, which are the reference for alignment. Then, before forming the vertical pattern 52 and the horizontal pattern 54, the position reference points 12 and 22 are aligned with an initial point, respectively.

As illustrated in FIG. 3, the first inkjet head 10 and the second inkjet head 20 of the inkjet printer in accordance with an embodiment of the present invention are aligned by taking the center of the first nozzle of each head as the position reference points 12 and 22. Then, by positioning the first nozzle of the second inkjet head 20 on a straight line, which is parallel with the printing direction of the second inkjet head 20, crossing a straight line passing through the first nozzle of the first inkjet head 10, the second inkjet head 20 is easily aligned during the printing by the second inkjet head 20. Accordingly, after finishing the printing by the first inkjet head 10, the second inkjet head 20 can be moved to the initial point in the horizontal direction by a distance “d,” making a perfect alignment of the position reference point 22 and the initial point. As a result, the printing direction of the second inkjet head 20 and a moving direction for aligning the initial point, i.e., the horizontal direction, become the same, thereby facilitating the alignment of the position reference point 22 and the initial point.

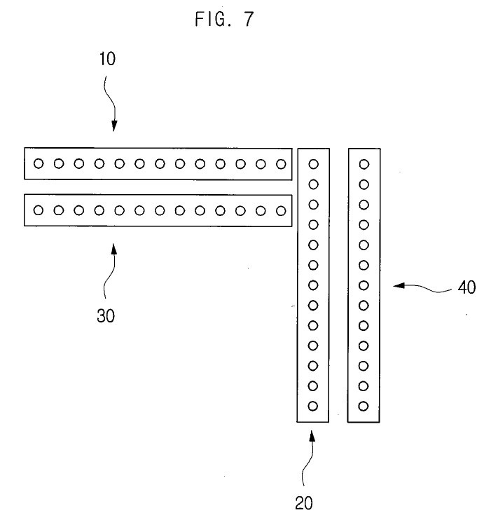

As illustrated in FIG. 7, the inkjet printer can also include a third inkjet head 30, which is arranged parallel to the first inkjet head 10 in the printing direction of the first inkjet head 10 or parallel to the second inkjet head 20 in the printing direction of the second inkjet head 20. The third inkjet head 30 of the inkjet printer in accordance with an embodiment of the present invention was disposed side-by-side with the first inkjet head 10 and inside the first inkjet head 10 and the second inkjet head 20, which form an “L” shaped configuration, such that the space for disposing the head is not increased. As a result, there are two rows of vertically-printing nozzles. The nozzles are configured in a manner that the nozzles are not vertically overlapped. Therefore, the number of nozzles for spraying to form the vertical pattern 52 at the same time is doubled, improving the printing capability for forming the vertical pattern 52 twice as much.

Furthermore, the inkjet printer in accordance with an embodiment of the present invention also includes a fourth inkjet head 40, which is disposed side-by-side with the second inkjet head 20 along the printing direction of the second inkjet head 20, thereby improving the printing capability for forming the horizontal pattern 54 twice as much.

Although multi-heads are formed to improve the printing capability, each pattern is still formed by a single nozzle corresponding to the pattern. As a result, any error occurred when aligning a plurality of heads does not affect the print pattern 50. Therefore, the multi-heads of the inkjet printer in accordance with an embodiment of the present invention can form the print pattern 50 that has a constant, precise line width.

Described below is a printing method using the inkjet printer described above.

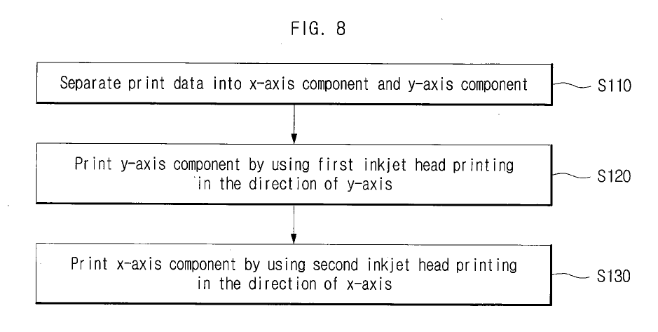

FIG. 8 is a flowchart illustrating a printing method in accordance with an embodiment of the present invention.

First of all, in accordance with the printing method based on an embodiment of the present invention, print data 60 is divided into an x-axis component 64 and a y-axis component 62 (S110).

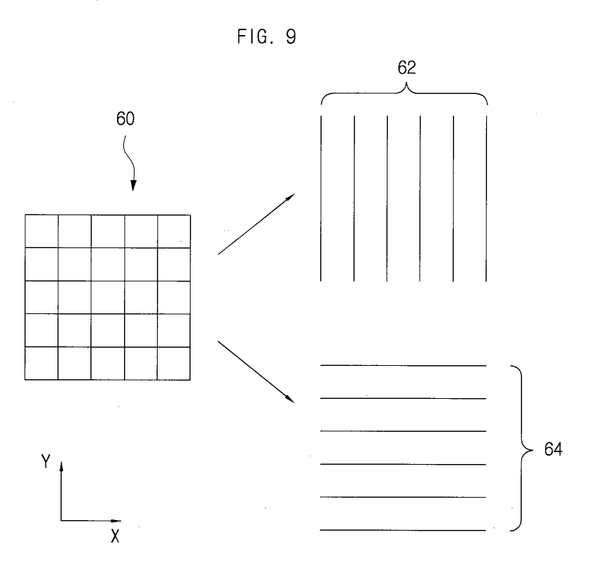

Referring to FIG. 9, in order to form the print pattern 50 by using the first inkjet head 10 and the second inkjet head 20, the print data 60 is divided into two parts, one for printing by the first inkjet head 10 and the other for printing by the second inkjet head 20. The printing method in accordance with an embodiment of the present invention performs the printing by using the first inkjet head 10 and the second inkjet head 20 that cross each other at right angles. Accordingly, the print data 60 is divided into a vertical component, i.e., the y-axis component 62, which is to be printed by the first inkjet head 10 to print in the vertical direction, and a horizontal component, i.e., the x-axis component 64, which is to be printed by the second inkjet head 20 to print in the horizontal direction.

Then, the y-axis component 62 is printed by using the first inkjet head 10, which prints in the vertical direction, and the x-axis component 64 is printed by using the second inkjet head 20, which prints in the horizontal direction (S120 and S130). Here, there is no restriction on the order of printing between the first inkjet head 10 and the second inkjet head 20.

Referring to FIGS. 4 and 5, as described above, after aligning the first inkjet head 10 printing in the vertical direction, the vertical pattern 52 is successively formed using each nozzle corresponding to each vertical pattern 52. In the same way, the horizontal pattern 54 is formed by the second inkjet head 20 printing in the horizontal direction.

Therefore, the print pattern 50, formed by the printing method in accordance with an embodiment of the present invention, has the vertical pattern 52 and the horizontal pattern 54 that are uniform in printing quality and thus minimize product defects when forming a fine print pattern.

In accordance with the present invention as set forth above, the inkjet printer can print a pattern that has a plurality of directions with a stable quality.

While the spirit of the invention has been described in detail with reference to a certain embodiment, the embodiment is for illustrative purposes only and shall not limit the invention. It is to be appreciated that those skilled in the art can change or modify the embodiment without departing from the scope and spirit of the invention. As such, many embodiments other than that set forth above can be found in the appended claims.

What is claimed is:

1. An inkjet printer comprising:
a first inkjet head configured to print in one direction; and
a second inkjet head configured to print in a different direction intersecting the one direction.

2. The inkjet printer of claim 1, wherein the one direction of printing of the first inkjet head intersects the different direction of printing of the second inkjet head at right angles.

3. The inkjet printer of claim 1, wherein:
the first inkjet head and the second inkjet head have a position reference point becoming a reference for aligning a inkjet head; and
the position reference point of the second inkjet head is directed toward the different direction and is located on a straight line passing through the position reference point of the first inkjet head.

4. The inkjet printer of claim 1 further comprising a third inkjet head configured to be arranged in parallel with the first inkjet head along the printing direction of the first inkjet head or in parallel with the second inkjet head along the printing direction of the second inkjet head.

5. A printing method comprising:
separating print data into an x-axis component and a y-axis component;
printing the y-axis component by using a first inkjet head printing in the direction of y-axis; and
printing the x-axis component by using a second inkjet head printing in the direction of x-axis.
